(19) United States
(12) Patent Application Publication
(10) Pub. No.: US 2025/0343493 A1
(43) Pub. Date: Nov. 6, 2025

(54) ELECTROLYTIC CAPACITOR-LESS DRIVING SYSTEM AND CONTROL METHOD THEREOF

(71) Applicant: QINGDAO HISENSE HITACHI AIR-CONDITIONING SYSTEMS CO., LTD., Shandong (CN)

(72) Inventors: Xuexiang JIANG, Qingdao (CN); Xizhi LI, Qingdao (CN); Jinwei ZHOU, Qingdao (CN); Zhaoting REN, Qingdao (CN); Haojie YIN, Qingdao (CN)

(73) Assignee: QINGDAO HISENSE HITACHI AIR-CONDITIONING SYSTEMS CO., LTD., Shandong (CN)

(21) Appl. No.: 19/269,008

(22) Filed: Jul. 14, 2025

Related U.S. Application Data
(63) Continuation of application No. PCT/CN2024/077819, filed on Feb. 20, 2024.

(30) Foreign Application Priority Data
May 17, 2023 (CN) 202310560647.9

(51) Int. Cl. H02P 21/22; H02P 27/08

(52) U.S. Cl. CPC H02P 21/22; H02P 27/08; H02P 2207/05

(57) ABSTRACT

An electrolytic capacitor-less motor driving system includes a motor, a frequency converter and a controller. The controller is configured to: correct a coordinate transformation angle according to an electrical angular velocity of the motor, a bus voltage and a bus voltage reference value to obtain a corrected coordinate transformation angle, the coordinate transformation angle being an included angle between a current vector direction and a positive direction of an α axis, and the corrected coordinate transformation angle is configured to cause an included angle between the current vector direction and a positive direction of a d axis to be zero; and determine the pulse width modulation signal according to a three-phase current output by the frequency converter, a d-axis reference current, a q-axis reference current and the corrected coordinate transformation angle, and input the pulse width modulation signal to the frequency converter.

### CROSS-REFERENCE TO RELATED APPLICATION

This application is a continuation of international PCT application serial no. PCT/CN2024/077819, filed on Feb. 20, 2024, which claims the priority benefit of China application no. 202310560647.9, filed on May 17, 2023. The entirety of each of the above mentioned patent applications is hereby incorporated by reference herein and made a part of this specification.

### TECHNICAL FIELD

The present disclosure relates to the field of driving control of permanent magnet synchronous motors, and in particular, to an electrolytic capacitor-less driving system and a control method thereof.

### DESCRIPTION OF RELATED ART

A permanent magnet synchronous motor (PMSM) provides excitation with a permanent magnet. The PMSM is increasingly applied in industrial and household-appliance fields due to a high power efficiency, a simple structure, a low cost, or the like.

### SUMMARY

In an aspect, an electrolytic capacitor-less motor driving system is provided. The electrolytic capacitor-less motor driving system includes a motor, a frequency converter and a controller. The frequency converter is coupled to the motor and configured to receive a pulse width modulation signal and determine a three-phase voltage according to the pulse width modulation signal, so as to drive the motor to work. The controller is coupled to the motor and the frequency converter. The controller is configured to correct a coordinate transformation angle according to an electrical angular velocity of the motor, a bus voltage and a bus voltage reference value, to obtain a corrected coordinate transformation angle. The coordinate transformation angle is an included angle between a current vector direction and a positive direction of an α axis in a two-phase stationary rectangular coordinate system, and the corrected coordinate transformation angle is configured to cause an included angle between the current vector direction and a positive direction of a d axis in a two-phase rotating rectangular coordinate system to be zero. The controller is further configured to determine the pulse width modulation signal according to a three-phase current output by the frequency converter, a d-axis reference current, a q-axis reference current and the corrected coordinate transformation angle, and input the pulse width modulation signal to the frequency converter.

In another aspect, a control method of an electrolytic capacitor-less motor driving system is provided. The electrolytic capacitor-less motor driving system includes a motor, a frequency converter and a controller. The frequency converter is coupled to the motor and configured to receive a pulse width modulation signal and determine a three-phase voltage according to the pulse width modulation signal, so as to drive the motor to work. The method includes:
correcting a coordinate transformation angle according to an electrical angular velocity of the motor, a bus voltage and a bus voltage reference value to obtain a corrected coordinate transformation angle, where the coordinate transformation angle is an included angle between a current vector direction and a positive direction of an α axis in a two-phase stationary rectangular coordinate system, and the corrected coordinate transformation angle is configured to cause an included angle between the current vector direction and a positive direction of a d axis in a two-phase rotating rectangular coordinate system to be zero; and
determining the pulse width modulation signal according to a three-phase current output by the frequency converter, a d-axis reference current, a q-axis reference current and the corrected coordinate transformation angle, and inputting the pulse width modulation signal to the frequency converter.

### BRIEF DESCRIPTION OF THE DRAWINGS

FIG. 1 is a block diagram of a motor driving system in the related art;

FIG. 2 is a schematic diagram showing a relationship between a quadrature-axis current control error and a bus voltage error in the related art;

FIG. 3 is a block diagram of an electrolytic capacitor-less motor driving system according to some embodiments;

FIG. 4 is a circuit diagram of a frequency converter according to some embodiments;

FIG. 5 is a flow chart of a control method of an electrolytic capacitor-less driving system according to some embodiments;

FIG. 6 is a schematic diagram showing a phase relationship of multiple coordinate systems according to some embodiments;

FIG. 7 is a block diagram of an I/F control strategy according to some embodiments;

FIG. 8 is a flow chart of another control method of an electrolytic capacitor-less driving system according to some embodiments;

FIG. 9 is a schematic diagram showing a phase relationship between a two-phase rotating rectangular coordinate system and a target rectangular coordinate system in an initial state according to some embodiments;

FIG. 10 is a schematic diagram showing a phase relationship between the two-phase rotating rectangular coordinate system and the target rectangular coordinate system in a power generation state according to some embodiments;

FIG. 11 is a schematic diagram showing a relationship between a bus voltage deviation value and a correction value of a coordinate transformation angle in some embodiments;

FIG. 12 is a block diagram of a control strategy for a bus voltage of the electrolytic capacitor-less driving system according to some embodiments;

FIG. 13 is a schematic diagram of a bus voltage control effect in the related art;

FIG. 14 is a schematic diagram of a bus voltage control effect in some embodiments;

FIG. 15 is a flow chart of yet another control method of an electrolytic capacitor-less driving system according to some embodiments;

FIG. 16 is a schematic diagram showing a relationship between a γ-axis current and a torque of the γ-axis current in some embodiments; and

FIG. 17 is a block diagram of a bus voltage control apparatus in some embodiments.

### DESCRIPTION OF THE EMBODIMENTS

Some embodiments of the present disclosure are clearly and completely described below with reference to the accompanying drawings, and apparently, the described embodiments are not all but only a part of the embodiments of the present disclosure. All other embodiments obtained by a person of ordinary skill in the art based on the embodiments of the present disclosure shall fall within the protection scope of the present disclosure.

Unless required otherwise in the context, throughout the specification and the claims, the term “comprise” and its other forms such as “comprises” and “comprising” are interpreted as open and inclusive meaning “including, but not limited to”. In the description of the specification, the terms “one embodiment”, “some embodiments”, “exemplary embodiments”, “example”, “specific example”, “some examples”, or the like, are intended to indicate that a particular feature, structure, material, or characteristic in connection with the embodiment or example is included in at least one embodiment or example of the present disclosure. The schematic representations of the above terms do not necessarily refer to the same embodiment or example. In addition, the particular feature, structure, material, or characteristic may be included in any suitable manner in any one or more embodiments or examples.

Hereinafter, the terms such as “first” and “second” are used herein for purposes of description and are not intended to indicate or imply relative importance or significance or to imply the number of indicated technical features. Thus, the feature defined with “first” and “second” may include one or more of this feature explicitly or implicitly. In the description of some embodiments of the present disclosure, “a plurality” means two or more unless otherwise specified.

In describing some embodiments, the expressions “coupled” and “connected” along with their derivatives may be used. The term “connected” is to be interpreted broadly, and for example, “connected” may be a fixed connection, a detachable connection, or an integral connection; may be a direct connection or indirect connection via an intermediate medium. For example, the term “coupled” indicates that two or more components are in direct physical or electrical contact. The terms “coupled” or “communicatively coupled” may also mean that two or more components are not in direct contact with each other, but yet still cooperate or interact with each other. The embodiments disclosed herein are not necessarily limited to the contents herein.

“At least one of A, B, and C” and “at least one of A, B, or C” have the same meaning and both include the following combinations of A, B, and C: A alone, B alone, C alone, a combination of A and B, a combination of A and C, a combination of B and C, and a combination of A, B, and C.

The use of “adapted to” or “configured for” herein means open and inclusive languages and does not exclude devices adapted to or configured for performing additional tasks or steps.

As used herein, “about”, “roughly”, or “approximately” includes the stated value as well as an average value within an acceptable deviation range for the particular value as determined by one of ordinary skill in the art in view of the measurement in question and the error associated with measuring the particular quantity (i.e., the limitations of the measurement system).

As used herein, “parallel”, “perpendicular”, and “equal” include the stated case and cases that approximate the stated case and have ranges within an acceptable deviation range as determined by one of ordinary skill in the art in view of the measurement in question and the error associated with measuring the particular quantity (i.e., the limitations of the measurement system).

A thin-film capacitor has the characteristics of a small volume, a low cost and a long service life, so that a cost and a volume of a motor driving system can be reduced by adopting the thin-film capacitor, and reliability of a circuit is improved. Such a motor driving system with a non-electrolytic capacitor (e.g., thin-film capacitor) may be referred to as an electrolytic capacitor-less motor driving system or an electrolytic capacitor-less driving system. However, a capacitance value of the thin-film capacitor is small compared to a large-capacitance electrolytic capacitor, and thus, a capacitance value of a bus capacitor of an electrolytic capacitor-less driving system of a permanent magnet synchronous motor (PMSM) is low.

Under this condition, in the processes of upwind starting of a fan and rapid frequency rising and reduction of the PMSM, a bus voltage is prone to be overcharged, and devices on a driving board are prone to be damaged due to an overvoltage. In some solutions, an electromagnetic torque may be limited by a quadrature-axis (q-axis) current to prevent overvoltage of the bus (that is, prevent the bus voltage from being excessively increased). In addition, a system loss may be controlled by a direct-axis (d-axis) current to improve a dynamic performance of the motor during braking to prevent overvoltage of the bus.

For example, during an overvoltage on a direct current side, a current of an inductor between a rectifier and a direct current side capacitor (e.g., thin-film capacitor) drops to zero, and a diode in the rectifier is reverse-biased. Electromagnetic energy Ee on a motor side can be expressed as the following formula:

$$Ee = \frac{3}{2} {\int }_{Δ \text{?}} p [ {φ}_{i} + ( {L}_{d} - {L}_{q} ) {i}_{\text{?}} ] {i}_{q} {ω}_{e} dt \qquad ( 1 )$$

$$\text{?} \text{indicates text missing or illegible when filed}$$

where p is the number of pole pairs of the motor, φ_{f} is a rotor flux linkage, L_{d} is a d-axis inductance, L_{q} is a q-axis inductance, and We is an electrical angular frequency of a rotor. When the electromagnetic energy Ee flows into the direct current side capacitor, the bus voltage on the direct current side rises. Therefore, in a regenerative braking process, the electromagnetic energy Ee can be adjusted by adjusting the q-axis current to adjust energy flowing into the capacitor, preventing overvoltage of the bus on the direct current side.

It should be noted that regenerative braking is also called feedback braking. When regenerative braking occurs, a rotation speed of the motor is lower than that of a mechanical load, and a torque direction of the motor is opposite to that of the rotation speed (that is, a mechanical braking torque is provided on a rotating shaft of the motor). In this case, a part of kinetic or potential energy can be converted into electrical energy and stored or utilized, and therefore, regenerative braking can be understood as a process of energy recovery.

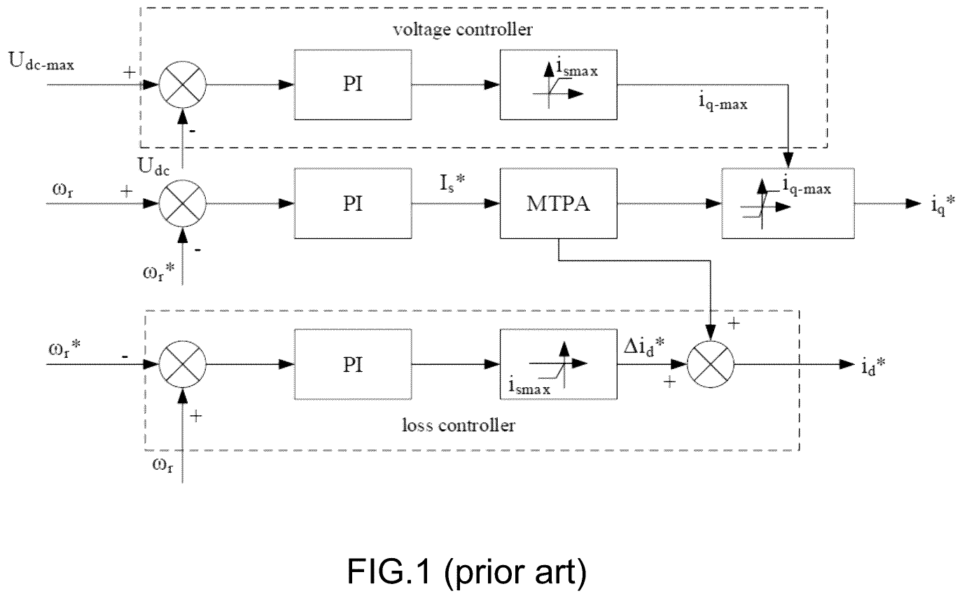

FIG. 1 is a block diagram of a motor driving system in the related art. As shown in FIG. 1, the motor driving system determines a q-axis current limit value i_{q-max} according to a bus voltage reference value U_{dc-max} and a bus voltage U_{dc}. Under the condition that the motor driving system is in an electric mode, the bus voltage U_{dc} is smaller than the bus voltage reference value U_{dc-max}, an output of a voltage controller is continuously increased, and therefore, the q-axis current limit value i_{q-max} can be adjusted to a maximum q-axis current limit value iₛ₋ₘₐₓ. In this case, the voltage controller is in a forward saturation state. Under the condition that the motor driving system is in a regenerative braking mode, the bus voltage U_{dc} is larger than the bus voltage reference value U_{dc-max}, and the q-axis current limit value i_{q-max} is reduced, so as to limit a negative q-axis current. In this way, the motor driving system can prevent the overvoltage of the bus on the direct current side by inhibiting regenerative braking.

It should be noted that the electric mode may be understood as the case where the motor is energized and normally works.

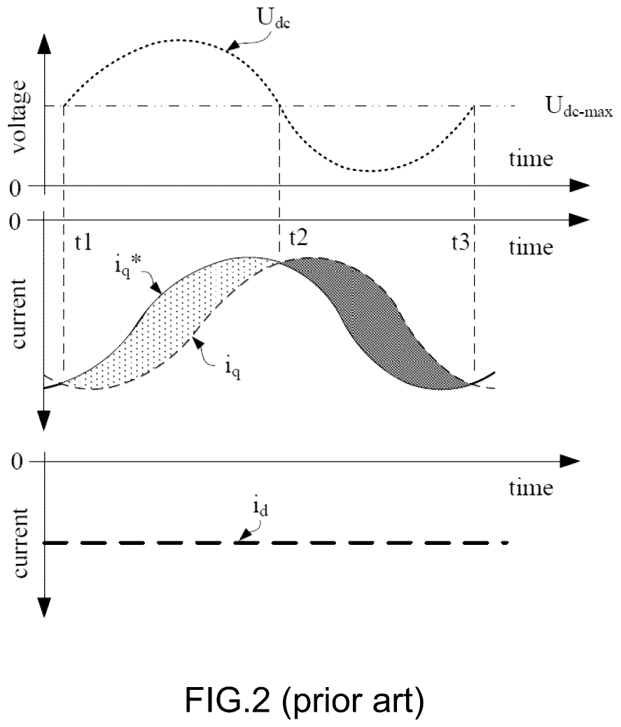

FIG. 2 is a schematic diagram of a relationship between a q-axis current control error and a bus voltage error in the related art. As shown in FIG. 2, a d-axis current i_{d} is approximately constant during one fluctuation period. During regenerative braking, the bus voltage U_{dc} is increased if a q-axis reference current i_{q}* (i.e., an instruction value or reference value of the quadrature-axis current) is greater than the q-axis current i_{q}. If the q-axis reference current i_{q}* is smaller than the q-axis current i_{q}, the bus voltage U_{dc} is decreased.

For example, in a partial interval from a first time point t1 to a second time point t2, the bus voltage U_{dc} is increased and is greater than the bus voltage reference value U_{dc-max}. In a partial interval from the second time point t2 to a third time point t3, the bus voltage U_{dc} is decreased and is smaller than the bus voltage reference value U_{dc-max}. Here, the q-axis current i_{q} can be understood as an actual current or a feedback current of the motor.

Therefore, in the motor driving system with the electrolytic capacitor having a large capacitance value, the bus voltage on the direct current side can be prevented from being excessively large according to a braking strategy for a motor loss (i.e., strategy for controlling the d-axis current i_{d}). However, this solution may fail in the electrolytic capacitor-less driving system due to control errors.

In order to solve the above problem, some embodiments of the present disclosure provide an electrolytic capacitor-less driving system. The driving system obtains a bus voltage, and corrects a coordinate transformation angle according to the bus voltage and a bus voltage reference value, so as to control the bus voltage to be close to the bus voltage reference value, thereby realizing closed-loop control over the bus voltage by the electrolytic capacitor-less driving system, and effectively preventing overvoltage of the bus.

Here, correcting the coordinate transformation angle according to the bus voltage and the bus voltage reference value may be correcting the coordinate transformation angle according to a bus voltage deviation value between the bus voltage and the bus voltage reference value. Therefore, when the bus voltage deviation value is large, the coordinate transformation angle can be greatly corrected; and when the bus voltage deviation value is small, the coordinate transformation angle is slightly corrected.

In some embodiments, the electrolytic capacitor-less driving system 1000 may be applied to various control systems, for example, an air conditioner. The air conditioner may include a multi-split air conditioner.

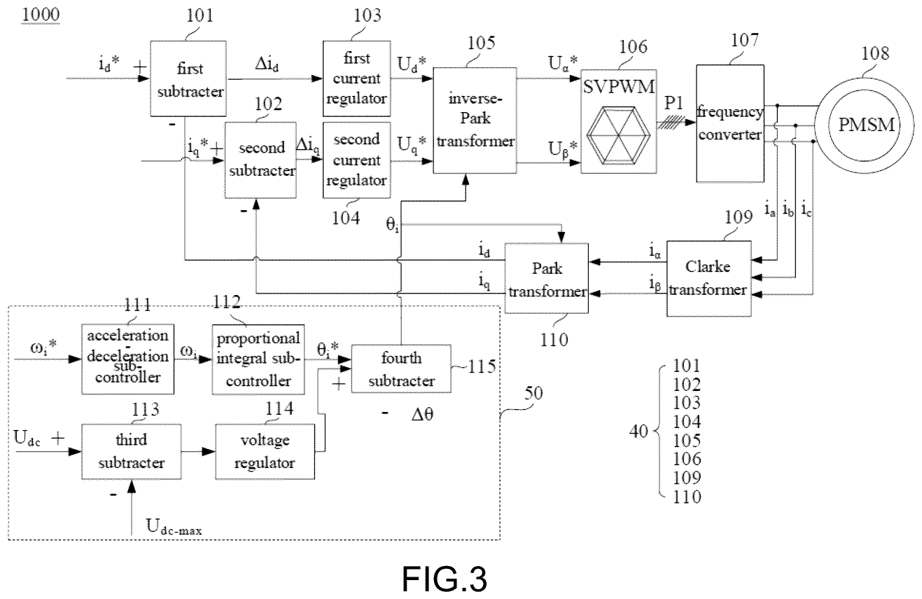

FIG. 3 is a block diagram of an electrolytic capacitor-less driving system according to some embodiments. As shown in FIG. 3, the electrolytic capacitor-less driving system 1000 includes a permanent magnet synchronous motor 108, a frequency converter 107, a first controller 40, and a second controller 50.

The frequency converter 107 is coupled to the motor 108, and is configured to receive a pulse width modulation signal and determine a three-phase voltage according to the pulse width modulation signal, so as to drive the motor 108 to work.

The first controller 40 is coupled to the permanent magnet synchronous motor 108 and the frequency converter 107, and is configured to obtain a three-phase current output by the frequency converter 107, a d-axis reference current, a q-axis reference current, and a corrected coordinate transformation angle, and determine the pulse width modulation signal according to the three-phase current, the d-axis reference current, the q-axis reference current, and the corrected coordinate transformation angle.

The second controller 50 is coupled to the first controller 40, and is configured to obtain an electrical angular velocity, a bus voltage, and a bus voltage reference value, and determine the corrected coordinate transformation angle according to the electrical angular velocity, the bus voltage, and the bus voltage reference value. The coordinate transformation angle is an included angle between a current vector direction and a positive direction of an α axis in a two-phase stationary rectangular coordinate system, and the corrected coordinate transformation angle is configured to cause an included angle between the current vector direction and a positive direction of a d axis in a two-phase rotating rectangular coordinate system to be zero.

In some embodiments, as shown in FIG. 3, the first controller 40 includes a first subtracter 101, a second subtracter 102, a first current regulator 103, a second current regulator 104, an inverse-Park transformer 105, a space vector pulse width modulation (SVPWM) apparatus 106, a Clarke transformer 109, and a Park transformer 110.

In some embodiments, the first subtracter 101 is coupled to the Park transformer 110 and the first current regulator 103, respectively. The first subtracter 101 is configured to perform subtraction on a d-axis current i_{d} obtained by transformation of the Park transformer 110 and a d-axis reference current i_{d}* (i.e., instruction value or reference value of the d-axis current) to obtain a d-axis current difference Δi_{d}, and transmit the d-axis current difference Δi_{d} to the first current regulator 103.

For example, as shown in FIG. 3, a first input end of the first subtracter 101 is configured to receive the d-axis reference current i_{d}*, a second input end of the first subtracter 101 is coupled to a first output end of the Park transformer 110, and an output end of the first subtracter 101 is coupled to an input end of the first current regulator 103.

In some embodiments, the second subtracter 102 is coupled to the Park transformer 110 and the second current regulator 104, respectively. The second subtracter 102 is configured to perform subtraction on a q-axis current i_{q} obtained by transformation of the Park transformer 110 and a q-axis reference current i_{q}* (i.e., instruction value or reference value of the q-axis current) to obtain a q-axis current difference Δi_{q}, and input the q-axis current difference Δi_{q} to the second current regulator 104.

For example, as shown in FIG. 3, a first input end of the second subtracter 102 is configured to receive the q-axis reference current i_{q}*, a second input end of the second subtracter 102 is coupled to a second output end of the Park transformer 110, and an output end of the second subtracter 102 is coupled to an input end of the second current regulator 104.

In some embodiments, the first current regulator 103 is coupled to the inverse-Park transformer 105, and configured to convert the d-axis current difference Δi_{d} into a d-axis reference voltage U_{d}* (i.e., instruction value or reference value of a d-axis voltage) and input the d-axis reference voltage to the inverse-Park transformer 105. For example, as shown in FIG. 3, an output end of the first current regulator 103 is coupled to a first input end of the inverse-Park transformer 105.

In some embodiments, the second current regulator 104 is coupled to the inverse-Park transformer 105 and configured to convert the q-axis current difference Δi_{q} into a q-axis reference voltage U_{q}* (i.e., instruction value or reference value of a q-axis voltage) and input the q-axis reference voltage to the inverse-Park transformer 105. For example, as shown in FIG. 3, an output end of the second current regulator 104 is coupled to a second input end of the inverse-Park transformer 105.

In some embodiments, the first current regulator 103 and the second current regulator 104 may both be proportional integral (PI) controllers.

In some embodiments, the inverse-Park transformer 105 is coupled to the SVPWM apparatus 106 and configured to convert the d-axis reference voltage Ua* and the q-axis reference voltage U_{q}* to an α-axis voltage U_{α}* and a β-axis voltage U_{β}* in a two-phase stationary rectangular coordinate system (α-β), respectively. For example, as shown in FIG. 3, a first output end of the inverse-Park transformer 105 is coupled to a first input end of the SVPWM apparatus 106, and a second output end of the inverse-Park transformer 105 is coupled to a second input end of the SVPWM apparatus 106.

In some embodiments, the SVPWM apparatus 106 is coupled to the frequency converter 107 and configured to calculate a PWM duty cycle value according to the α-axis voltage U_{α}* and the β-axis voltage U_{β}* to generate a desired voltage vector, thereby driving the frequency converter 107 to output a three-phase voltage.

SVPWM means that taking an ideal flux linkage circle of a three-phase symmetric motor stator when a three-phase symmetric sine wave voltage is used for supplying power as a reference standard, different switching modes of a three-phase inverter are properly switched, so as to form a PWM wave, and an accurate flux linkage circle thereof is simulated by a formed actual flux linkage vector. A sine pulse width modulation (SPWM) method generates a frequency-and-voltage-adjustable sine wave power supply from a power supply perspective, while the SVPWM method can consider the inverter and an asynchronous motor as a whole, a model is simpler, and real-time control of a microprocessor is also facilitated.

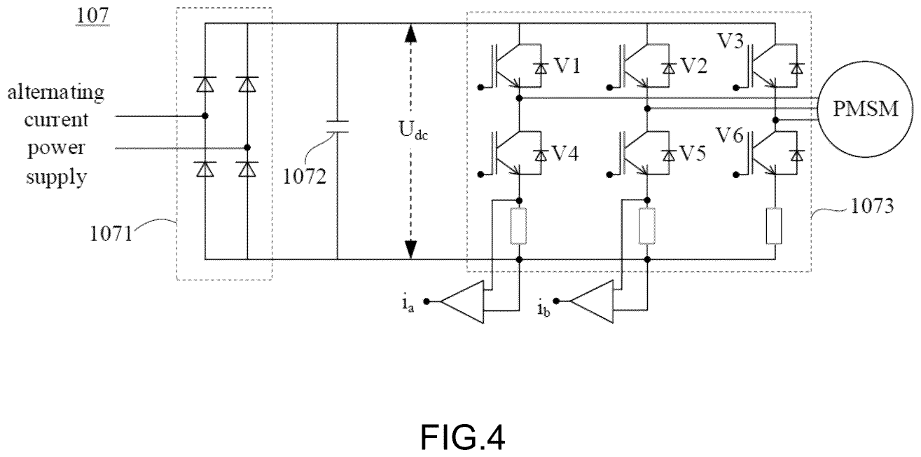

For example, a three-phase full bridge includes three half bridges formed by six switching devices (e.g., V1 to V6 in FIG. 4). The six switching devices can form 8 switching states. Here, the switching states of upper and lower bridge arms on the same bridge arm are opposite. When 0 and 1 are respectively used to indicate the off and on state of a half bridge arm (such as the upper bridge arm or the lower bridge arm), in the case where the switching states of the three upper bridge arms are 000 or 111, the motor does not generate an effective current during driving, and therefore, the voltage vectors corresponding to the two switching states (i.e., 000 and 111) may be referred to as zero vectors. In this case, the voltage vectors corresponding to the other 6 switching states are six effective vectors (may also be referred to as basic vectors). The six effective vectors may divide a 360° voltage space into six 60° sectors.

With the six effective vectors and the two zero vectors, any vector within 360° can be synthesized. When a vector is to be synthesized, the vector is first decomposed to two basic vectors nearest to it, and then, the vector is represented using the two basic vectors. An action time of each basic vector indicates an action intensity of each basic vector. In this way, the required voltage vector can be synthesized with different action time ratios of the basic vectors, thereby generating a voltage waveform approximating a sine wave.

When a variable frequency motor is driven, a vector direction is continuously changed, so that the vector action time needs to be continuously calculated. For the convenience of computer processing, a timing calculation is performed by a timer when the required voltage vector is synthesized. For example, the timer sets timing such that a calculation is performed once every 0.1 ms. Thus, the required voltage vector can be synthesized by calculating the action times of the two basic vectors within 0.1 ms. Since the sum of the calculated action times of the two basic vectors may be less than 0.1 ms, the action time of the appropriate zero vector may be inserted into the remaining time as the case may be. Since the driving waveform synthesized during processing is similar to the PWM waveform and the driving waveform is synthesized based on the vectors of a voltage space, it is called SVPWM.

In some embodiments, the frequency converter 107 is coupled to the PMSM 108 and configured to receive a pulse width modulation signal and determine a three-phase voltage according to the pulse width modulation signal, so as to drive the PMSM 108 to work.

FIG. 4 is a circuit diagram of the frequency converter in some embodiments. In some examples, as shown in FIG. 4, the frequency converter 107 includes a rectification circuit 1071, a non-electrolytic capacitor 1072, and a three-phase inverter circuit 1073. The rectification circuit 1071 is configured to convert an input alternating current power into a direct current power, and the three-phase inverter circuit 1073 is connected to the rectification circuit 1071 and configured to convert the direct current power into a three-phase alternating current power under the control of the SVPWM, thereby driving the PMSM to work by the three-phase alternating current power. The non-electrolytic capacitor 1072 is arranged between the rectification circuit 1071 and the three-phase inverter circuit 1073, and is configured to store energy.

The three-phase inverter circuit 1073 includes six switching devices V1 to V6, and an output end of the SVPWM apparatus 106 is respectively coupled to control ends (e.g., gates) of the six switching devices.

It should be noted that the structure of the frequency converter 107 shown in FIG. 4 is only an example, and the frequency converter 107 for driving the PMSM 108 may include other structures, which is not limited in the present disclosure.

In some embodiments, the PMSM 108 can be a motor that is defined differently according to a counter electromotive force of the motor, such as a sinusoidal counter electromotive force permanent magnet synchronous motor.

In some embodiments, the motor (e.g., PMSM 108) includes a direct axis (d axis) and a quadrature axis (q axis), the d axis and the q axis are the axes of a coordinate system established based on the motor rotor, and the coordinate system rotates synchronously with the rotor, so that the coordinate system (d-q) is a two-phase rotating rectangular coordinate system. A magnetic field direction of the rotor is the d axis, and a direction perpendicular to the magnetic field direction of the rotor is the q axis.

In some embodiments, the motor further includes a γ axis and a δ axis, and a coordinate system (γ-δ) formed by the γ axis and the δ axis is also a two-phase rotating rectangular coordinate system. Here, the two-phase rotating rectangular coordinate system (γ-δ) is a target rectangular coordinate system of the two-phase rotating rectangular coordinate system (d-q).

It should be noted that the two-phase rotating rectangular coordinate system (d-q) may be understood as a coordinate system corresponding to actual rotation of the motor rotor, and the target rectangular coordinate system (γ-δ) may be understood as a coordinate system corresponding to theoretical rotation of the motor rotor.

In some embodiments, the motor further includes an α axis and a β axis, and a coordinate system (α-β) formed by the α axis and the β axis is an established two-phase stationary rectangular coordinate system, and the coordinate system (α-β) is stationary.

In some embodiments, the Clarke transformer 109 is coupled to the frequency converter 107 and configured to receive three-phase currents iₐ, i_{b} and i_{c} and convert the three-phase currents iₐ, i_{b} and i_{c} into the α-axis current i_{α} and the β-axis current i_{β}.

For example, as shown in FIG. 3, an input end of the Clarke transformer 109 is coupled to an output end of the frequency converter 107.

Here, conversion of a sinusoidal current in a three-phase stationary 120° coordinate system (a-b-c) to a sinusoidal current in the two-phase stationary rectangular coordinate system (α-β) is referred to as Clarke transformation.

It should be noted that for a stator, the α-axis current i_{α} and the β-axis current i_{β} are orthogonal currents.

In some embodiments, the Park transformer 110 is coupled to the Clarke transformer 109 and configured to receive the α-axis current i_{α} and the β-axis current i_{β}, convert the α-axis current i_{α} and the β-axis current i_{β} into the d-axis current i_{d} and the q-axis current i_{q} respectively, transmit the d-axis current i_{d} to the first subtracter 101 and transmit the q-axis current i_{q} to the second subtracter 102.

For example, a first input end of the Park transformer 110 is coupled to an output end of the Clarke transformer 109.

Here, the d-axis current i_{d} and the q-axis current i_{q} are orthogonal currents in the two-phase rotating rectangular coordinate system (d-q), and conversion of the sinusoidal current in the two-phase stationary rectangular coordinate system (α-β) into a constant current in the two-phase rotating rectangular coordinate system (d-q) is referred to as Park transformation.

In some embodiments, the d-axis current i_{d} and the q-axis current i_{q} are constant under the condition of stable operation of the motor. The above-mentioned “stable operation” means that the rotation speed and torque of the motor do not change within a period of time, and the motor is in the stable operation in this state.

In some embodiments, as shown in FIG. 3, the second controller 50 includes an acceleration-deceleration sub-controller 111, a proportional integral sub-controller 112, a third subtracter 113, a voltage regulator 114, and a fourth subtracter 115.

In some embodiments, the acceleration-deceleration sub-controller 111 is coupled to the proportional integral sub-controller 112 and configured to convert the obtained electrical angular velocity ωᵢ* into an angular velocity ωᵢ of a current vector and transmit the angular velocity ωᵢ of the current vector to the proportional integral sub-controller 112.

For example, as shown in FIG. 3, an input end of the acceleration-deceleration sub-controller 111 is configured to receive the obtained electrical angular velocity ωᵢ, and an output end of the acceleration-deceleration sub-controller 111 is coupled to an input end of the proportional integral sub-controller 112.

It should be noted that the electrical angular velocity ωᵢ* refers to an angle of electric power transmitted in a circuit per unit time, i.e., an angular velocity of a current. In an alternating current circuit, the electrical angular velocity ωᵢ* varies with a change of a direction of the current. Thus, the electrical angular velocity ωᵢ* may be used to describe an operating state of the electrolytic capacitor-less driving system 1000.

The electrolytic capacitor-less driving system 1000 may be provided with a rotation speed sensor. When the motor rotates, the rotation speed sensor generates a corresponding pulse waveform, and the rotation speed sensor generates a fixed number of pulses when the motor rotates by one circle. By calculating a number of pulses in a fixed time, a mechanical angular velocity Or of the motor can be calculated.

It should be noted that there is a corresponding relationship between the electrical angular velocity ωᵢ* and the motor rotation speed f. When the motor rotates by one circle, a mechanical angle rotates by 360°. The electrical angular velocity ωᵢ* is obtained by multiplying 360° by the rotation speed f and then dividing by the number of pole pairs p (i.e., ωᵢ*=2πf/p). In this way, the electrical angular velocity ωᵢ* of the electrolytic capacitor-less driving system 1000 can be calculated by using the rotation speed sensor, thereby determining the angular velocity ωᵢ of the current vector of the electrolytic capacitor-less driving system 1000.

In addition, the current is a vector and has a magnitude and a direction. A current vector angle is the included angle between the direction of the current vector iₛ and the positive direction of the α axis in the two-phase stationary rectangular coordinate system (α-β). Since the α axis is stationary in the two-phase stationary rectangular coordinate system (α-β), the angular velocity ωᵢ of the current vector can be calculated according to the electrical angular velocity ωᵢ* and the positive direction of the α axis to determine the coordinate transformation angle θᵢ*.

In some embodiments, the acceleration-deceleration sub-controller 111 may be a speed and position observer.

In some embodiments, the proportional integral sub-controller 112 is coupled to the fourth subtracter 115 and configured to receive the angular velocity ωᵢ of the current vector, and perform proportion and integration on the angular velocity ωᵢ of the current vector to obtain the coordinate transformation angle θᵢ between the two-phase rotating rectangular coordinate system (d-q) and the two-phase stationary rectangular coordinate system (α-β).

For example, as shown in FIG. 3, an output end of the proportional integral sub-controller 112 is coupled to a first input end of the fourth subtracter 115.

In some embodiments, the third subtracter 113 is coupled to the voltage regulator 114 and configured to compare a bus voltage reference value U_{dc-max} with an obtained bus voltage U_{dc} to obtain a bus voltage deviation value and transmit the bus voltage deviation value to the voltage regulator 114.

For example, as shown in FIG. 3, a first input end of the third subtracter 113 is configured to receive the bus voltage U_{dc}, a second input end of the third subtracter 113 is configured to receive the bus voltage reference value U_{dc-max}, and an output end of the third subtracter 113 is coupled to an input end of the voltage regulator 114.

In some embodiments, the voltage regulator 114 is coupled to the fourth subtracter 115 and configured to receive the bus voltage deviation value, convert the bus voltage deviation value into a correction value Δθ of the coordinate transformation angle θᵢ*, and transmit the correction value Δθ of the coordinate transformation angle θᵢ* to the fourth subtracter 115.

For example, as shown in FIG. 3, an output end of the voltage regulator 114 is coupled to a second input end of the fourth subtracter 115.

In some embodiments, the fourth subtracter 115 is coupled to the inverse-Park transformer 105 and the Park transformer 110, and is configured to correct the coordinate transformation angle θᵢ* according to the correction value Δθ of the coordinate transformation angle θᵢ* to obtain a corrected coordinate transformation angle θᵢ, and transmit the corrected coordinate transformation angle θᵢ to the inverse-Park transformer 105 and the Park transformer 110.

For example, as shown in FIG. 3, an output end of the fourth subtracter 115 is coupled to a third input end of the inverse-Park transformer 105 and a second input end of the Park transformer 110.

In some embodiments, the proportional integral sub-controller 112 and the voltage regulator 114 may be PI controllers.

In some embodiments, the second controller 50 may be an apparatus generating an operation control signal according to an instruction operation code and a timing signal, and instructing the electrolytic capacitor-less driving system 1000 to execute a control instruction. For example, the second controller 50 may be a central processing unit (CPU), a general purpose processor network processor (NP), a digital signal processor (DSP), a microprocessor, a microcontroller, a programmable logic device (PLD), or any combination thereof. The second controller 50 may alternatively be other apparatuses with processing functions such as a circuit, a device, or software, which is not limited in the present disclosure.

In addition, the second controller 50 may be configured to control working of components in the electrolytic capacitor-less driving system, so that the electrolytic capacitor-less driving system 1000 operates to achieve preset functions of the electrolytic capacitor-less driving system 1000.

In some embodiments, the second controller 50 is configured to: obtain the electrical angular velocity ωᵢ*, and determine the angular velocity ωᵢ of the current vector according to the electrical angular velocity ωᵢ*; determine the coordinate transformation angle θᵢ* according to the angular velocity ωᵢ of the current vector; obtain the bus voltage U_{dc}, and correct the coordinate transformation angle θᵢ* according to the bus voltage U_{dc} and the bus voltage reference value U_{dc-max} to obtain the corrected coordinate transformation angle θᵢ; and transmit the corrected coordinate transformation angle θᵢ to the Park inverter 110 and the inverse-Park inverter 105 to cause the electrolytic capacitor-less driving system 1000 to realize overvoltage prevention control of the bus voltage.

In some embodiments, the second controller 50 is further configured to: obtain the bus voltage U_{dc}, and compare the bus voltage U_{dc} with the bus voltage reference value U_{dc-max} to obtain the bus voltage deviation value; determine the correction value Δθ of the coordinate transformation angle θᵢ* according to the bus voltage deviation value; and correct the coordinate transformation angle θᵢ* according to the correction value Δθ of the coordinate transformation angle θᵢ* to obtain the corrected coordinate transformation angle θᵢ.

A voltage sensor or a sampling resistor may be provided in the electrolytic capacitor-less driving system 1000. The bus voltage U_{dc} is detected by the voltage sensor or the sampling resistor, so that the second controller 50 obtains the bus voltage U_{dc}.

In some examples, the second controller 50 obtains the correction value Δθ of the coordinate transformation angle θᵢ* through the voltage regulator 114 therein.

In some embodiments, the second controller 50 is further configured to: in the case of upwind starting of the electrolytic capacitor-less driving system 1000, set the δ-axis current to a first preset value, and set the γ-axis current to a second preset value. The first preset value is a non-positive value and the second preset value is a non-negative value. That is, the first preset value is less than or equal to 0, and the second preset value is greater than or equal to 0.

It should be noted that the upwind starting may be understood to be the case where a rotation direction of the rotating shaft of the motor in the fan is opposite to a wind direction.

In some embodiments, the second controller 50 is further configured to: under the condition that a torque of the γ-axis current is detected to be larger than a preset threshold, adjust the γ-axis current to a third preset value; and under the condition that the torque of the γ-axis current is detected to be less than the preset threshold, adjust the γ-axis current to 0. Here, the third preset value is greater than 0.

It should be noted that a current sensor may be provided in the electrolytic capacitor-less driving system 1000. The torque of the γ-axis current is detected by the current sensor.

It is to be understood that the structure shown in FIG. 3 does not constitute a limitation of the electrolytic capacitor-less driving system 1000, and the electrolytic capacitor-less driving system 1000 may include more or less components than shown in FIG. 3, or some components may be combined, or a different arrangement of components is adopted.

In some embodiments, the first controller 40 and the second controller 50 may be the same controller. The controller may be a CPU, an NP, a DSP, a microprocessor, a microcontroller, a PLD, or any combination thereof. Alternatively, the controller may be other apparatuses with processing functions such as a circuit, a device, or software.

Some embodiments of the present disclosure further provide a control method of a electrolytic capacitor-less driving system to control a bus voltage. A subject for executing the method may be a bus voltage control apparatus, the above-described electrolytic capacitor-less driving system 1000, or an air conditioner having the above-described electrolytic capacitor-less driving system 1000. The bus voltage control apparatus may be a main control board or a part of the main control board in the air conditioner, or may be an additionally provided central processing unit or a combination of a CPU and a memory.

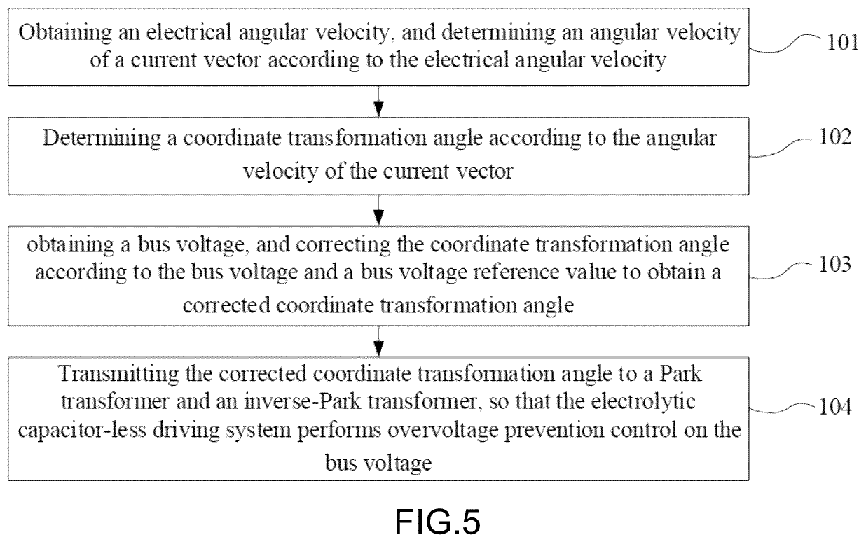

FIG. 5 is a flow chart of the control method of an electrolytic capacitor-less driving system according to some embodiments. As shown in FIG. 5, the control method includes steps 101 to 104.

In step 101, an electrical angular velocity is obtained, and an angular velocity of a current vector is determined according to the electrical angular velocity.

Reference may be made to the above related content for a detailed description of this step which is not repeated herein.

In step 102, a coordinate transformation angle is determined according to the angular velocity of the current vector.

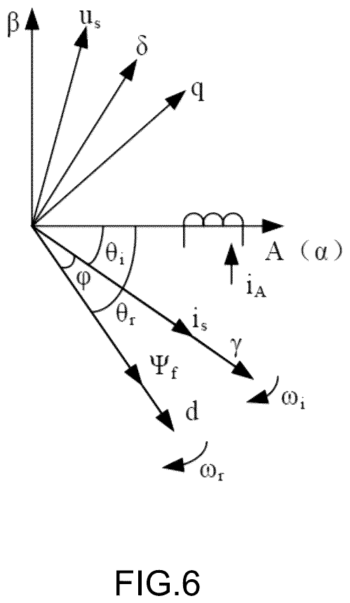

FIG. 6 is a schematic diagram showing a phase relationship of multiple coordinate systems in some embodiments. As shown in FIG. 6, FIG. 6 shows the two-phase stationary rectangular coordinate system (α-β), the two-phase rotating rectangular coordinate system (d-q), and the target rectangular coordinate system (γ-δ). It is assumed that the direction of the current vector iₛ serves as a positive direction of the γ axis, and a direction lagging behind the current vector iₛ by 90° is a positive direction of the δ axis. An included angle between the γ axis and the d axis is designated as a torque angle φ, an included angle between the γ axis and the α axis is designated as the coordinate transformation angle θᵢ, and an included angle between the d axis and the α axis is designated as “θᵣ”.

As shown in FIG. 6, the target rectangular coordinate system (γ-δ) may be obtained according to the two-phase stationary rectangular coordinate system (α-β) and the coordinate transformation angle θᵢ.

It may be appreciated that the coordinate transformation angle θᵢ is the included angle between the γ axis and the α axis. That is, the coordinate transformation angle θᵢ is a current vector angle of the included angle between the direction of the current vector iₛ and the positive direction of the α axis in the two-phase stationary rectangular coordinate system (α-β). Thus, the current vector angle can be calculated by integrating the angular velocity of the current vector with the time. That is, the coordinate transformation angle θᵢ is calculated by integrating the angular velocity of the current vector with the time.

It should be noted that the coordinate transformation angle θᵢ can be understood as the above-described corrected coordinate transformation angle θᵢ, i.e., a coordinate transformation angle acting on motor control.

In some embodiments, the electromagnetic torque Tₑ of the electrolytic capacitor-less driving system can be obtained by the following formula:

$${T}_{e} = \frac{3}{2} [ {Ψ}_{f} {i}_{q} + ( {L}_{d} - {L}_{q} ) {i}_{d} {i}_{q} ] \approx \frac{3}{2} {n}_{p} {Ψ}_{f} {i}_{q} = \frac{3}{2} {n}_{p} {Ψ}_{f} ( {i}_{δ} cos φ - {i}_{γ} sin φ ) \qquad ( 2 )$$

where nₚ denotes the number of pole pairs of the motor, and Ψ_{f} denotes the rotor flux linkage.

In some embodiments, in the case where the δ-axis current i_{δ} is equal to 0, formula (2) becomes formula (3), that is, the electromagnetic torque Tₑ can be obtained by formula (3):

$${T}_{e} = - \frac{3}{2} {n}_{p} {Ψ}_{f} {i}_{γ} sin φ \qquad ( 3 )$$

In some embodiments, the bus voltage of the electrolytic capacitor-less driving system can be controlled according to the coordinate transformation angle θᵢ through an I/F control strategy. Here, I in the I/F control strategy represents a stator current, and F represents a rotation frequency of the stator current in a space. The I/F control strategy may set a frequency function of the current to form a desired starting speed profile, then integrate the frequency to obtain a desired position angle, and provide the position angle to a current loop for coordinate transformation.

Here, the position angle represents a relative position of a rotor magnetic pole, and may be understood as a position of each phase axis of the motor or an angle of a position of the rotor of the motor in a 360° plane coordinate system. The current loop refers to a current feedback system which is an important part for receiving and processing feedback signals in a servo system. The current loop can control the current with high precision by reducing errors, so that a performance of the whole system is improved.

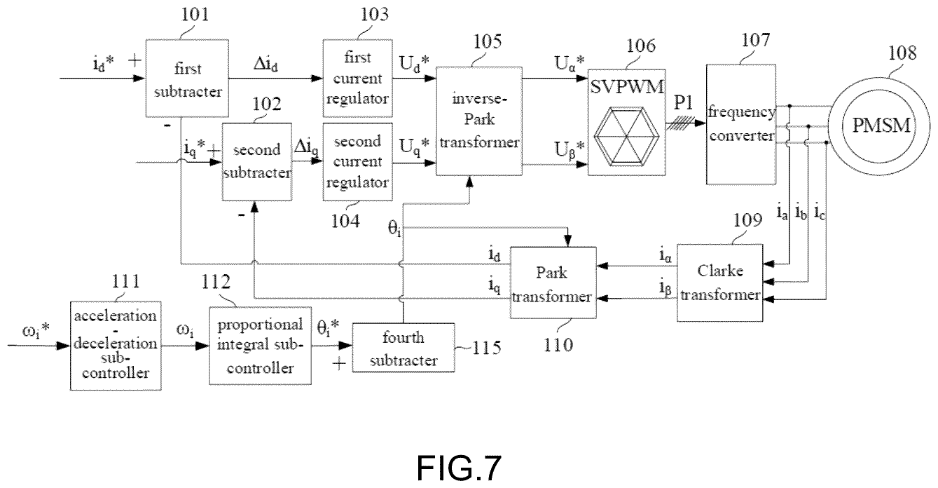

FIG. 7 is a block diagram of the I/F control strategy in some embodiments. As shown in FIG. 7, the electrolytic capacitor-less driving system determines the angular velocity ωᵢ of the current vector by the acceleration-deceleration sub-controller 111 after obtaining the electrical angular velocity ωᵢ*. The angular velocity ωᵢ of the current vector is transmitted to the proportional integral sub-controller 112 to obtain the coordinate transformation angle θᵢ*. Clarke transformation and Park transformation are carried out on the obtained three-phase currents iₐ, i_{b} and i_{c}, to obtain the d-axis current i_{d} and the q-axis current i_{q} under the two-phase rotating rectangular coordinate system (d-q). A difference between the d-axis reference current i_{d}* and the d-axis current i_{d}, is input to the first current regulator 103, and a difference between the q-axis reference current i_{q}* and the q-axis current i_{q} are input to the second current regulator 104.

When the electrolytic capacitor-less driving system is in a stable state, the d-axis current i_{d} is equal to the d-axis reference current i_{d}*, and the q-axis current i_{q} is equal to the q-axis reference current i_{q}*. Output values of the first current regulator 103 and the second current regulator 104 are used as the d-axis voltage U_{d}* and the q-axis voltage U_{q}* under the two-phase rotating rectangular coordinate system (d-q), and the d-axis voltage U_{d}* and the q-axis voltage U_{q}* are subjected to inverse-Park transformation to obtain the a-axis voltage U_{α}* and the β-axis voltage U_{β}* under the two-phase stationary rectangular coordinate system (α-β). The α-axis voltage U_{α}* and the β-axis voltage U_{β}* serve as inputs to the SVPWM apparatus. The SVPWM apparatus performs modulation based on the α-axis voltage U_{α}* and the β-axis voltage U_{β}* to generate 6 PWM waves, thereby controlling the inverter to output a target stator voltage.

It should be noted that the target stator voltage can be understood as a theoretical voltage required for the motor to reach a preset rotation speed.

In step 103, a bus voltage is obtained, and the coordinate transformation angle is corrected according to the bus voltage and a bus voltage reference value to obtain the corrected coordinate transformation angle.

Here, the bus voltage reference value may be preset during the design phase of the electrolytic capacitor-less driving system. For example, the bus voltage reference value is 700V. It may be appreciated that the bus voltage reference value may be other values.

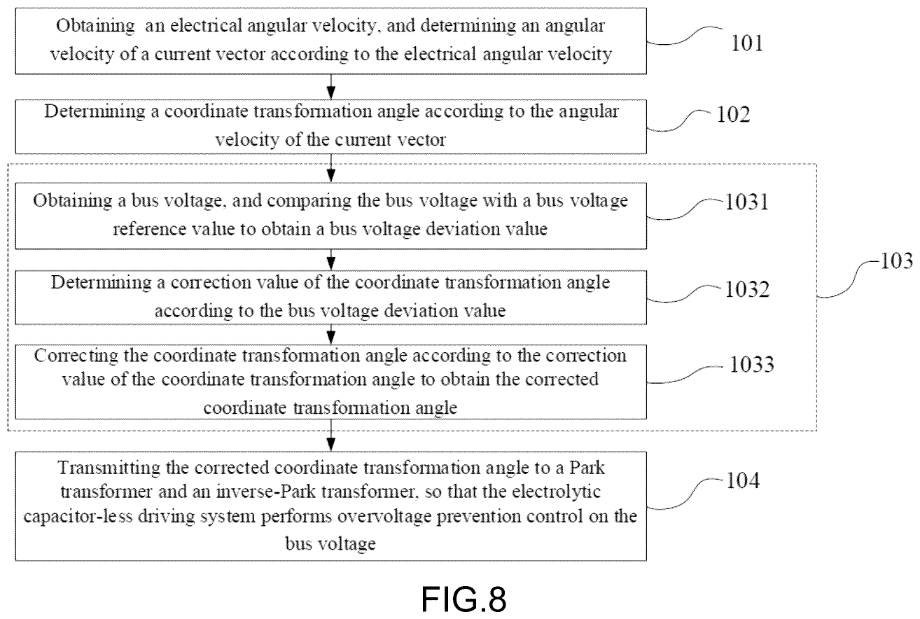

FIG. 8 is a flow chart of another control method of an electrolytic capacitor-less driving system according to some embodiments.

In some embodiments, as shown in FIG. 8, step 103 includes steps 1031 to 1032.

In step 1031, the bus voltage is obtained, and the bus voltage is compared with the bus voltage reference value to obtain a bus voltage deviation value.

In some examples, the bus voltage deviation value is obtained by subtracting the bus voltage reference value from the bus voltage.

For example, assuming that the bus voltage is 800V and the bus voltage reference value is 700V, the bus voltage deviation value is 100V.

In step 1032, a correction value of the coordinate transformation angle is determined according to the bus voltage deviation value.

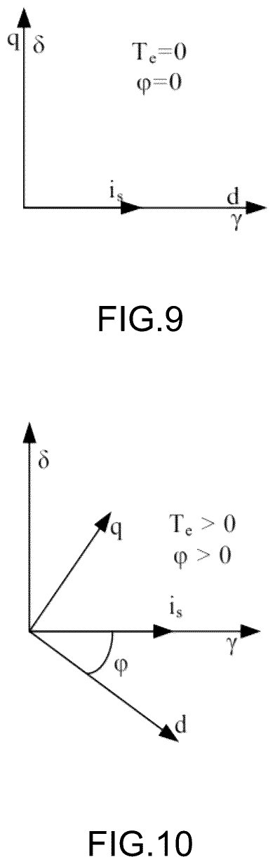

FIG. 9 is a schematic diagram showing a phase relationship between the two-phase rotating rectangular coordinate system and the target rectangular coordinate system in an initial state in some embodiments. As shown in FIG. 9, in the initial state, the positive direction of the d axis of the two-phase rotating rectangular coordinate system (d-q) coincides with the direction of the current vector iₛ. In this case, the included angle between the current vector iₛ and the d axis is 0°.

As can be seen from formula (3), when the included angle between the current vector iₛ and the d axis is 0°, that is, when the torque angle φ is equal to 0°, the electromagnetic torque Tₑ is equal to 0.

It should be noted that the initial state may be understood as a state at an initial starting moment of the motor.

FIG. 10 is a schematic diagram showing a phase relationship between the two-phase rotating rectangular coordinate system and the target rectangular coordinate system in a power generation state in some embodiments. As shown in FIG. 10, in the power generation state, an included angle exists between the positive direction of the d axis of the two-phase rotating rectangular coordinate system (d-q) and the current vector iₛ, that is, the included angle between the γ axis and the d axis is the torque angle φ. Here, the power generation state corresponds to the regenerative braking, and the power generation state can be understood as a state of the motor when the torque angle φ is an obtuse angle.

Since the two-phase rotating rectangular coordinate system (d-q) is stationary relative to the rotor, a velocity of the two-phase rotating rectangular coordinate system (d-q) is equal to the mechanical angular velocity ωᵣ of the motor. Since the positive direction of the γ axis of the target rectangular coordinate system (γ-δ) is the direction of the current vector iₛ, a velocity of the target rectangular coordinate system (γ-δ) is equal to the angular velocity ωᵢ of the current vector.

In the case where the velocity of the two-phase rotating rectangular coordinate system (d-q) is greater than the velocity of the target rectangular coordinate system (γ-δ) (that is, ωᵣ>ωᵢ), the torque angle φ increases, the electromagnetic torque Tₑ increases, and thus, energy on the motor side flows into the direct current side, resulting in an increase in the bus voltage which is prone to be excessively large.

Thus, the bus voltage may be controlled to be prevented from being excessively large by increasing the coordinate transformation angle θᵢ to decrease the torque angle φ.

The coordinate transformation angle may be corrected according to the deviation value between the bus voltage U_{dc} and the bus voltage reference value U_{dc-max}. That is, when the bus voltage deviation value is large, the correction value of the coordinate transformation angle is large. When the bus voltage deviation value is small, the correction value of the coordinate transformation angle is small. In this way, the bus voltage U_{dc} can be controlled to be close to the bus voltage reference value U_{dc-max}, thus preventing the bus voltage from being excessively large.

In some embodiments, step 1032 includes: inputting the bus voltage deviation value into the proportional integral sub-controller to obtain the correction value of the coordinate transformation angle.

In some embodiments, the electrolytic capacitor-less driving system is further configured to provide a first coordinate transformation angle correction value and a second coordinate transformation angle correction value. The first coordinate transformation angle correction value is larger than the second coordinate transformation angle correction value. The method further includes:
when the correction value of the coordinate transformation angle is larger than the first coordinate transformation angle correction value, taking the first coordinate transformation angle correction value as the correction value of the coordinate transformation angle; and
when the correction value of the coordinate transformation angle is smaller than the second coordinate transformation angle correction value, taking the second coordinate transformation angle correction value as the correction value of the coordinate transformation angle.

In this way, the correction value of the coordinate transformation angle can be between the first coordinate transformation angle correction value and the second coordinate transformation angle correction value.

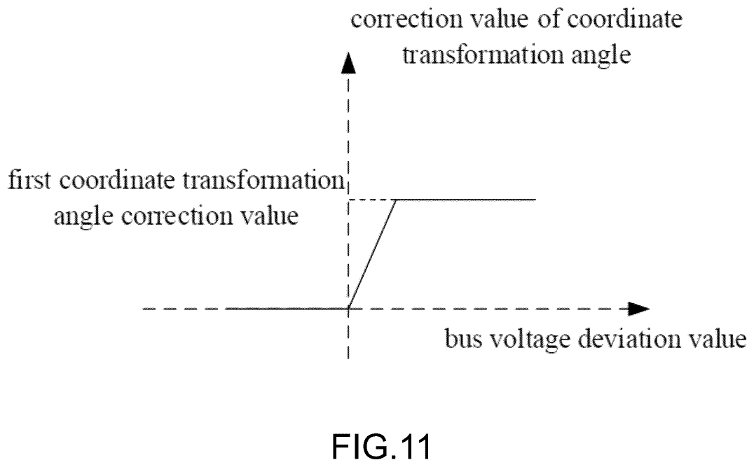

FIG. 11 is a schematic diagram showing a relationship between the bus voltage deviation value and the correction value of the coordinate transformation angle in some embodiments.

As shown in FIG. 11, the bus voltage deviation value and the correction value of the coordinate transformation angle have a partially linear relationship. When the bus voltage deviation value is less than 0 (i.e., the second coordinate transformation angle correction value), the correction value of the coordinate transformation angle is 0. When the bus voltage deviation value is greater than 0, the correction value of the coordinate transformation angle increases as the bus voltage deviation value increases. In the case where the correction value of the coordinate transformation angle is larger than the first coordinate transformation angle correction value, the first coordinate transformation angle correction value is used as the correction value of the coordinate transformation angle, and in this case, the correction value of the coordinate transformation angle is kept unchanged.

In step 1033, the coordinate transformation angle is corrected according to the correction value of the coordinate transformation angle to obtain the corrected coordinate transformation angle.

In the case of upwind starting of the electrolytic capacitor-less driving system, the coordinate transformation angle θᵢ has a negative value. In this case, subtracting the correction value of the coordinate transformation angle from the coordinate transformation angle θᵢ is equivalent to increasing the coordinate transformation angle θᵢ. That is, the corrected coordinate transformation angle θᵢ increases.

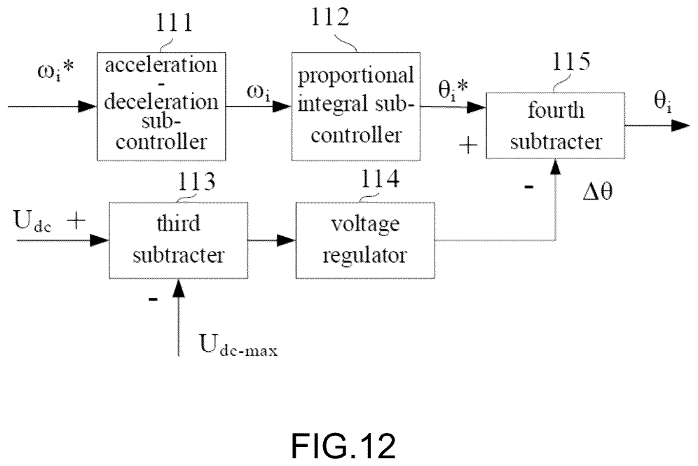

FIG. 12 is a block diagram of a control strategy for the bus voltage of the electrolytic capacitor-less driving system according to some embodiments. As shown in FIG. 12, after the bus voltage U_{dc} is obtained, the bus voltage is input to the third subtracter 113. The third subtracter 113 determines the bus voltage deviation value according to the bus voltage U_{dc} and the bus voltage reference value U_{dc-max} and transmits the bus voltage deviation value to the voltage regulator 114. After the bus voltage deviation value is transmitted to the voltage regulator 114 to obtain the correction value Δθ of the coordinate transformation angle, the correction value Δθ of the coordinate transformation angle is transmitted to the fourth subtracter 115. After the electrical angular velocity ωᵢ* is obtained, the angular velocity ωᵢ of the current vector is determined by the acceleration-deceleration sub-controller 111. The acceleration-deceleration sub-controller 111 transmits the angular velocity ωᵢ of the current vector to the proportional integral sub-controller 112 to obtain the coordinate transformation angle θᵢ*, and transmits the coordinate transformation angle θᵢ* to the fourth subtracter 115. The fourth subtracter 115 determines the corrected coordinate transformation angle θᵢ according to the coordinate transformation angle θᵢ* and the correction value Δθ of the coordinate transformation angle.

In step 104, the corrected coordinate transformation angle is transmitted to the Park transformer and the inverse-Park transformer, so that the electrolytic capacitor-less driving system performs overvoltage prevention control on the bus voltage.

After the corrected coordinate transformation angle θᵢ is obtained, the corrected coordinate transformation angle θᵢ may be transmitted to the Park transformer which may perform Park transformation according to the corrected coordinate transformation angle θᵢ. Likewise, the corrected coordinate transformation angle θᵢ may be transmitted to the inverse-Park transformer which may perform inverse-Park transformation according to the corrected coordinate transformation angle θᵢ. Therefore, the electrolytic capacitor-less driving system can realize the overvoltage prevention control of the bus voltage.

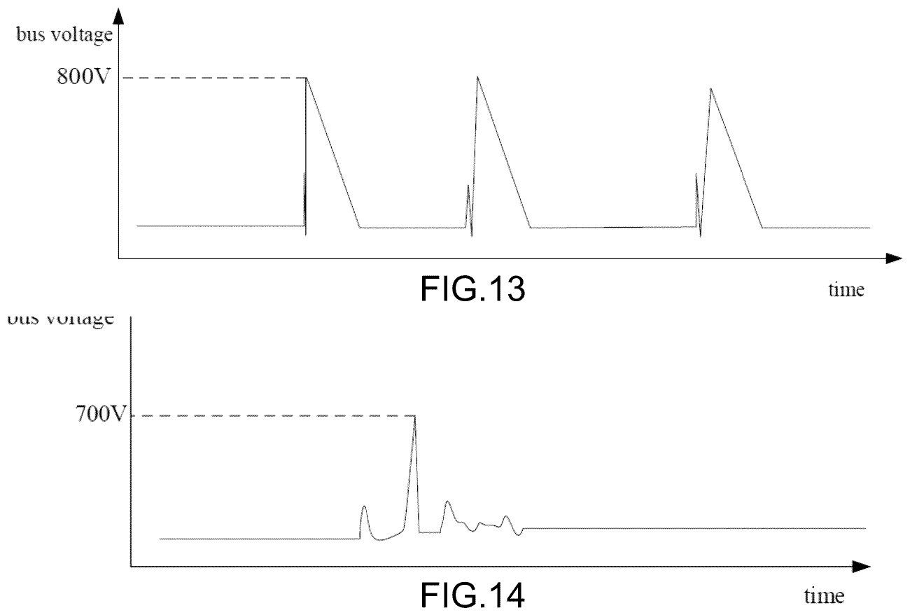

FIG. 13 is a schematic diagram of a bus voltage control effect in the related art. As shown in FIG. 13, in the related art, the bus voltage is controlled below 800V, and the number of fluctuations of the bus voltage is relatively large.

FIG. 14 is a schematic diagram of a bus voltage control effect in some embodiments of the present disclosure. As shown in FIG. 14, the control method according to some embodiments of the present disclosure can control the bus voltage below 700V, and the number of fluctuations of the bus voltage is relatively small.

It should be noted that the bus voltage equal to 700V in FIG. 14 is only an example, and the range in which the bus voltage is controlled is related to the bus voltage reference value U_{dc-max}.

In the control method of an electrolytic capacitor-less driving system according to some embodiments of the present disclosure, after the bus voltage is obtained, the coordinate transformation angle is corrected according to the bus voltage and the bus voltage reference value. Therefore, the coordinate transformation angle can be corrected according to the difference between the bus voltage and the bus voltage reference value, so that the bus voltage is controlled to be close to the bus voltage reference value, closed-loop control of the bus voltage is realized, and the bus overvoltage can be prevented in the electrolytic capacitor-less driving system.

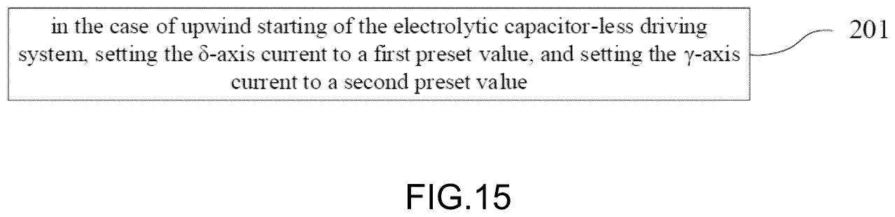

FIG. 15 is a flow chart of yet another control method of an electrolytic capacitor-less driving system according to some embodiments.

In some embodiments, as shown in FIG. 15, the control method further includes step 201.

In step 201, in the case of upwind starting of the electrolytic capacitor-less driving system, the δ-axis current is set to a first preset value, and the γ-axis current is set to a second preset value.

The first preset value is a non-positive value and the second preset value is a non-negative value. The first preset value and the second preset value may be preset during the design phase of the electrolytic capacitor-less driving system.

When the electrolytic capacitor-less driving system is in the initial state, the positive direction of the d axis of the two-phase rotating rectangular coordinate system (d-q) is consistent with the direction of the current vector iₛ. In this case, the included angle between the current vector iₛ and the d axis is 0°. That is, the torque angle φ is equal to 0°. From step 102, the electromagnetic torque Tₑ can be obtained according to formula (2). Therefore, by substituting the torque angle φ=0° into formula (2), formula (4) can be obtained:

$${T}_{e} = \frac{3}{2} {n}_{p} {Ψ}_{f} {i}_{δ} \qquad ( 4 )$$

In some embodiments, in the case where the δ-axis current i_{δ} has a positive value, during upwind starting of the electrolytic capacitor-less driving system, the electromagnetic torque of the electrolytic capacitor-less driving system is in the power generation state, so that the energy on the motor side flows into the direct current side, and the bus voltage is increased to cause the overvoltage. Therefore, the first preset value is set to a non-positive value.

In some other embodiments, in some special cases, the electromagnetic torque of the electrolytic capacitor-less driving system is independent of the δ-axis current i_{δ} and is related to the γ-axis current i_{γ}. In this case, the δ-axis current i_{δ} may be set to a non-negative value to avoid that the electromagnetic torque of the electrolytic capacitor-less driving system is in the power generation state during upwind starting of the electrolytic capacitor-less driving system. Therefore, the second preset value is set to a non-negative value.

For example, in the case where the torque angle φ is equal to 90° (i.e., the above special case), the torque angle φ is substituted into formula (2), and formula (5) can be obtained:

$${T}_{e} = - \frac{3}{2} {n}_{p} {Ψ}_{f} {i}_{γ} \qquad ( 5 )$$

In this case, in order to avoid that the electromagnetic torque of the electrolytic capacitor-less driving system is in the power generation state during upwind starting of the electrolytic capacitor-less driving system, that is, the electromagnetic torque is larger than 0 (i.e., Tₑ>0), the δ-axis current i_{δ} may be set to a non-negative value.

In some embodiments, the method further includes: under the condition that the torque of the γ-axis current is detected to be larger than a preset threshold, adjusting the γ-axis current to a third preset value; and under the condition that the torque of the γ-axis current is detected to be less than the preset threshold, adjusting the γ-axis current to 0.

The preset threshold may be preset during the design phase of the electrolytic capacitor-less driving system. The third preset value is greater than 0.

As can be seen from formula (2), the same torque angle may result in different electromagnetic torques (e.g., different γ-axis currents and different δ-axis currents result in different electromagnetic torques), a proportional and integral coefficient (i.e., the proportional and integral coefficient in the PI controller) is constant, and therefore, the second preset value is set in a step change manner. For example, under the condition that the torque of the γ-axis current is larger than the preset threshold, the γ-axis current is adjusted to the third preset value; and under the condition that the torque of the γ-axis current is less than the preset threshold, the γ-axis current is adjusted to 0. Thus, the problem of coupling of the γ-axis current and correction of the coordinate transformation angle can be solved.

It should be noted that the step change may be understood to be a sudden jump of a parameter from one value to another. The coupling problem means that the γ-axis current and the δ-axis current, or the d-axis current and the q-axis current, or the α-axis current and the β-axis current influence each other in the control process, resulting in an error of system control.

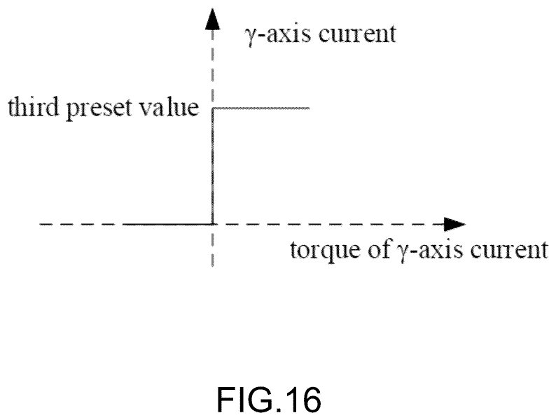

FIG. 16 is a schematic diagram of a relationship between the γ-axis current and the torque of the γ-axis current in some embodiments. As shown in FIG. 16, when the torque of the γ-axis current is smaller than 0, the γ-axis current is adjusted to 0. Under the condition that the torque of the γ-axis current is greater than 0, the γ-axis current is adjusted to the third preset value.

Some embodiments of the present disclosure further provide a bus voltage control apparatus of the electrolytic capacitor-less driving system. The bus voltage control apparatus may include one or more functional portions to implement the above control method of a electrolytic capacitor-less driving system.

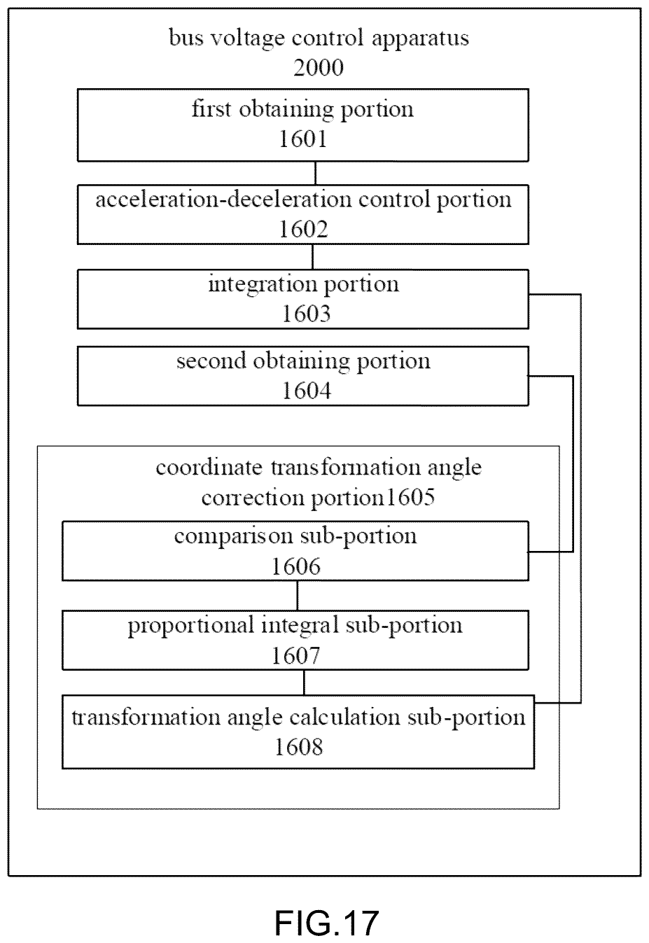

For example, FIG. 17 is a block diagram of the bus voltage control apparatus in some embodiments. As shown in FIG. 17, the bus voltage control apparatus 2000 includes: a first obtaining portion 1601, an acceleration-deceleration control portion 1602, an integration portion 1603, a second obtaining portion 1604, and a coordinate transformation angle correction portion 1605. The first obtaining portion 1601, the acceleration-deceleration control portion 1602, the integration portion 1603, the second obtaining portion 1604, and the coordinate transformation angle correction portion 1605 are connected to each other.

The first obtaining portion 1601 is configured to obtain an electrical angular velocity of the electrolytic capacitor-less driving system.

The acceleration-deceleration control portion 1602 is coupled to the first obtaining portion 1601 and configured to determine an angular velocity of a current vector according to the electrical angular velocity.

The integration portion 1603 is coupled to the first acquisition portion 1601 and configured to determine a coordinate transformation angle according to the angular velocity of the current vector.

The second obtaining portion 1604 is configured to obtain a bus voltage of the electrolytic capacitor-less driving system.

The coordinate transformation angle correction portion 1605 is coupled to the second acquisition portion 1604 and configured to determine a correction value of the coordinate transformation angle according to the bus voltage and a bus voltage reference value, and correct the coordinate transformation angle, so as to transmit a corrected coordinate transformation angle to a Park transformer and an inverse-Park transformer, so that the electrolytic capacitor-less driving system realizes overvoltage prevention control of the bus voltage.

In some embodiments, the coordinate transformation angle correction portion 1605 includes: a comparison sub-portion 1606, a proportional integral sub-portion 1607, and a transformation angle calculation sub-portion 1608.

The comparison sub-portion 1606 is coupled to the second acquisition portion 1604, and configured to compare the bus voltage with the bus voltage reference value to obtain a bus voltage deviation value.

The proportional integral sub-portion 1607 is coupled to the comparison sub-portion 1606 and configured to determine the correction value of the coordinate transformation angle according to the bus voltage deviation value.

The transformation angle calculation sub-portion 1608 is coupled to the proportional integral sub-portion 1607 and the integration portion 1603, and is configured to determine the corrected coordinate transformation angle according to the coordinate transformation angle and the correction value of the coordinate transformation angle.

Various steps described in the drawings of some embodiments of the present disclosure in a particular order do not require or imply that the steps must be performed in that particular order or that all of the illustrated steps must be performed to achieve desirable results. Various steps in the drawings may be added, certain steps may be omitted, multiple steps may be combined into one step, or one step may be divided into multiple steps.

In the above embodiments, the corresponding ends and devices may be implemented in whole or in part by software, hardware, firmware, or any combination thereof. When implemented using a software program, the corresponding ends and devices may be implemented in whole or in part in the form of a computer program product. The computer program product includes one or more computer-executable instructions. The processes or functions described according to the embodiments of the present application are generated in whole or in part when the computer-executable instructions are loaded and executed on a computer. The computer may be a general purpose computer, a special purpose computer, a computer network, or other programmable apparatuses. The computer-executable instructions may be stored in a computer-readable storage medium or transmitted from one computer-readable storage medium to another, for example, the computer-executable instructions may be transmitted from one website, computer, server, or data center to another website, computer, server, or data center in a wired (e.g., coaxial cable, optical fiber, and digital subscriber line (DSL)) or wireless (e.g., infrared, radio, microwave, or the like) manner. The computer-readable storage medium can be any available medium that can be accessed by the computer or a data storage device including one or more available media integrated servers, data centers, or the like. The available medium may be a magnetic medium (e.g., floppy disk, hard disk, and magnetic tape), an optical medium (e.g., DVD), or a semiconductor medium (e.g., solid state disk (SSD)).

In the foregoing description of the embodiments, the particular features, structures, materials, or characteristics may be combined in any suitable manner in any one or more embodiments or examples.

It will be understood by those skilled in the art that the scope of the disclosure of the present disclosure is not limited to the particular embodiments described above, and that modifications and substitutions of certain elements of the embodiments may be made without departing from the spirit of the disclosure. The scope of the present disclosure is limited by the appended claims.

What is claimed is:

1. An electrolytic capacitor-less motor driving system, comprising:
a motor;
a frequency converter, coupled to the motor, wherein the frequency converter is configured to receive a pulse width modulation signal and determine a three-phase voltage according to the pulse width modulation signal to drive the motor to work; and
a controller, coupled to the motor and the frequency converter, wherein the controller is configured to:
correct a coordinate transformation angle according to an electrical angular velocity of the motor, a bus voltage and a bus voltage reference value, to obtain a corrected coordinate transformation angle, wherein the coordinate transformation angle is an included angle between a current vector direction and a positive direction of an α axis in a two-phase stationary rectangular coordinate system, and the corrected coordinate transformation angle is configured to cause an included angle between the current vector direction and a positive direction of a d axis in a two-phase rotating rectangular coordinate system to be zero; and
determine the pulse width modulation signal according to a three-phase current output by the frequency converter, a d-axis reference current, a q-axis reference current and the corrected coordinate transformation angle, and input the pulse width modulation signal to the frequency converter.

2. The electrolytic capacitor-less motor driving system according to claim 1, wherein the controller comprises a first controller and a second controller, and the second controller is configured to correct the coordinate transformation angle according to the electrical angular velocity of the motor, the bus voltage and the bus voltage reference value, to obtain the corrected coordinate transformation angle, wherein the first controller comprises:
a Clarke transformer, coupled to the frequency converter, and configured to receive the three-phase current and convert the three-phase current into an α-axis current and a β-axis current in the two-phase stationary rectangular coordinate system;
a Park transformer, coupled to the Clarke transformer, wherein the Park transformer is configured to receive the α-axis current and the β-axis current and convert the α-axis current and the β-axis current to a d-axis current and a q-axis current in the two-phase rotating rectangular coordinate system respectively based on the corrected coordinate transformation angle;
a first subtracter, coupled to the Park transformer, and configured to perform a subtraction on the d-axis current obtained by a transformation of the Park transformer and the d-axis reference current to obtain a d-axis current difference;
a second subtracter, coupled to the Park transformer, and configured to perform a subtraction on the q-axis current obtained by the transformation of the Park transformer and the q-axis reference current to obtain a q-axis current difference;
a first current regulator, coupled to the first subtracter, and configured to convert the d-axis current difference to a d-axis reference voltage;
a second current regulator, coupled to the second subtracter, and configured to convert the q-axis current difference to a q-axis reference voltage;
an inverse-Park transformer, coupled to the first current regulator and the second current regulator, wherein the inverse-Park transformer is configured to convert the d-axis reference voltage and the q-axis reference voltage to an α-axis voltage and a β-axis voltage in the two-phase stationary rectangular coordinate system, respectively, based on the corrected coordinate transformation angle; and
a space vector pulse width modulation apparatus, coupled to the inverse-Park transformer and the frequency converter, wherein the space vector pulse width modulation apparatus is configured to calculate a duty cycle value of pulse width modulation signal according to the α-axis voltage and the β-axis voltage to generate a voltage vector to drive the frequency converter to output the three-phase voltage.

3. The electrolytic capacitor-less motor driving system according to claim 2, wherein the second controller comprises:
an acceleration-deceleration sub-controller, configured to convert an obtained electrical angular velocity into an angular velocity of a current vector;
a proportional integral sub-controller, coupled to the acceleration-deceleration sub-controller, wherein the proportional integral sub-controller is configured to receive the angular velocity of the current vector, and perform a proportion and integration on the angular velocity of the current vector to obtain the coordinate transformation angle;
a third subtracter, configured to compare the bus voltage reference value with an obtained bus voltage to obtain a bus voltage deviation value;
a voltage regulator, coupled to the third subtracter, and configured to receive the bus voltage deviation value and convert the bus voltage deviation value into a correction value of the coordinate transformation angle; and
a fourth subtracter, coupled to the proportional integral sub-controller, the voltage regulator, the Park transformer, and the inverse-Park transformer, wherein the fourth subtracter is configured to correct the coordinate transformation angle according to the correction value of the coordinate transformation angle to obtain the corrected coordinate transformation angle, and transmit the corrected coordinate transformation angle to the Park transformer and the inverse-Park transformer.

4. The electrolytic capacitor-less motor driving system according to claim 3, wherein the second controller is further configured to:
when the correction value of the coordinate transformation angle is larger than a first coordinate transformation angle correction value, determine that the correction value of the coordinate transformation angle is equal to the first coordinate transformation angle correction value; and
when the correction value of the coordinate transformation angle is smaller than a second coordinate transformation angle correction value, determine that the correction value of the coordinate transformation angle is equal to the second coordinate transformation angle correction value;
wherein the first coordinate transformation angle correction value is larger than the second coordinate transformation angle correction value.

5. The electrolytic capacitor-less motor driving system according to claim 4,
wherein under a condition that the bus voltage deviation value is less than 0, the correction value of the coordinate transformation angle is 0;
wherein under a condition that the bus voltage deviation value is greater than 0, the correction value of the coordinate transformation angle increases as the bus voltage deviation value increases, and when the correction value of the coordinate transformation angle is greater than the first coordinate transformation angle correction value, the correction value of the coordinate transformation angle is the first coordinate transformation angle correction value.

6. The electrolytic capacitor-less motor driving system according to claim 4, wherein the second controller is further configured to:
under a condition of upwind starting of the electrolytic capacitor-less motor driving system, set a δ-axis current to a first preset value, and set a γ-axis current to a second preset value; wherein a δ axis and a γ axis are coordinate axes of a target rectangular coordinate system of the two-phase rotating rectangular coordinate system, and a positive direction of the γ axis is a direction of the current vector;
wherein the first preset value is less than or equal to 0, and the second preset value is greater than or equal to 0.

7. The electrolytic capacitor-less motor driving system according to claim 5, wherein the second controller is further configured to:
under a condition that a torque of the γ-axis current is detected to be larger than a preset threshold, adjust the γ-axis current to a third preset value; and
under a condition that the torque of the γ-axis current is detected to be smaller than the preset threshold, adjust the γ-axis current to 0;
wherein the third preset value is greater than 0.

8. The electrolytic capacitor-less motor driving system according to claim 1, wherein the controller is configured to:
determine an angular velocity of the current vector according to the electrical angular velocity;
perform a proportional and integral control on the angular velocity of the current vector to obtain the coordinate transformation angle;
compare the bus voltage with a bus voltage reference value to obtain a bus voltage deviation value; and
determine the correction value of the coordinate transformation angle according to the bus voltage deviation value, and correct the coordinate transformation angle according to the correction value to obtain the corrected coordinate transformation angle.

9. The electrolytic capacitor-less motor driving system according to claim 8, wherein the controller is further configured to:
when the correction value of the coordinate transformation angle is larger than a first coordinate transformation angle correction value, determine that the correction value of the coordinate transformation angle is equal to the first coordinate transformation angle correction value; and
when the correction value of the coordinate transformation angle is smaller than a second coordinate transformation angle correction value, determining that the correction value of the coordinate transformation angle is equal to the second coordinate transformation angle correction value;
wherein the first coordinate transformation angle correction value is larger than the second coordinate transformation angle correction value.

10. The electrolytic capacitor-less motor driving system according to claim 9,
wherein under a condition that the bus voltage deviation value is less than 0, the correction value of the coordinate transformation angle is 0;
wherein under a condition that the bus voltage deviation value is greater than 0, the correction value of the coordinate transformation angle increases as the bus voltage deviation value increases, and when the correction value of the coordinate transformation angle is greater than the first coordinate transformation angle correction value, the correction value of the coordinate transformation angle is the first coordinate transformation angle correction value.

11. The electrolytic capacitor-less motor driving system according to claim 1, wherein the controller is further configured to:
under a condition of upwind starting of the electrolytic capacitor-less motor driving system, set a δ-axis current to a first preset value, and set a γ-axis current to a second preset value; wherein a δ axis and a γ axis are coordinate axes of a target rectangular coordinate system of the two-phase rotating rectangular coordinate system, and a positive direction of the γ axis is a direction of the current vector;
wherein the first preset value is less than or equal to 0, and the second preset value is greater than or equal to 0.

12. The electrolytic capacitor-less motor driving system according to claim 11, wherein the controller is further configured to:
under a condition that a torque of the γ-axis current is detected to be larger than a preset threshold, adjust the γ-axis current to a third preset value; and
under a condition that the torque of the γ-axis current is detected to be smaller than the preset threshold, adjust the γ-axis current to 0;
wherein the third preset value is greater than 0.

13. A control method of an electrolytic capacitor-less motor driving system, wherein the electrolytic capacitor-less motor driving system comprises:
a motor; and
a frequency converter, coupled to the motor, wherein the frequency converter is configured to receive a pulse width modulation signal and determine a three-phase voltage according to the pulse width modulation signal to drive the motor to work;
wherein the method comprises:
correcting a coordinate transformation angle according to an electrical angular velocity of the motor, a bus voltage and a bus voltage reference value, to obtain a corrected coordinate transformation angle, wherein the coordinate transformation angle is an included angle between a current vector direction and a positive direction of an α axis in a two-phase stationary rectangular coordinate system, and the corrected coordinate transformation angle is configured to cause an included angle between the current vector direction and a positive direction of a d axis in a two-phase rotating rectangular coordinate system to be zero; and
determining the pulse width modulation signal according to a three-phase current output by the frequency converter, a d-axis reference current, a q-axis reference current and the corrected coordinate transformation angle, and inputting the pulse width modulation signal to the frequency converter.

14. The method according to claim 13, wherein determining the corrected coordinate transformation angle according to the electrical angular velocity, the bus voltage and the bus voltage reference value comprises:
determining an angular velocity of the current vector according to the electrical angular velocity;
determining the coordinate transformation angle according to the angular velocity of the current vector; and
correcting the coordinate transformation angle according to the bus voltage and a bus voltage reference value to obtain the corrected coordinate transformation angle.

15. The method according to claim 14, wherein correcting the coordinate transformation angle according to the bus voltage and the bus voltage reference value to obtain the corrected coordinate transformation angle comprises:
comparing the bus voltage with the bus voltage reference value to obtain a bus voltage deviation value;
determining a correction value of the coordinate transformation angle according to the bus voltage deviation value; and
correcting the coordinate transformation angle according to the correction value of the coordinate transformation angle to obtain the corrected coordinate transformation angle.

16. The method according to claim 15, wherein determining the correction value of the coordinate transformation angle according to the bus voltage deviation value comprises:
inputting the bus voltage deviation value into a proportional integral sub-controller to obtain the correction value of the coordinate transformation angle.

17. The method according to claim 16, further comprising:
when the correction value of the coordinate transformation angle is larger than a first coordinate transformation angle correction value, determining that the correction value of the coordinate transformation angle is equal to the first coordinate transformation angle correction value; and
when the correction value of the coordinate transformation angle is smaller than a second coordinate transformation angle correction value, determining that the correction value of the coordinate transformation angle is equal to the second coordinate transformation angle correction value;
wherein the first coordinate transformation angle correction value is larger than the second coordinate transformation angle correction value.

18. The method according to claim 17, wherein under a condition that the bus voltage deviation value is less than 0, the correction value of the coordinate transformation angle is 0; and
wherein under a condition that the bus voltage deviation value is greater than 0, the correction value of the coordinate transformation angle increases as the bus voltage deviation value increases, and when the correction value of the coordinate transformation angle is greater than the first coordinate transformation angle correction value, the correction value of the coordinate transformation angle is the first coordinate transformation angle correction value.

19. The method according to claim 13, further comprising:
under a condition of upwind starting of the electrolytic capacitor-less motor driving system, setting a δ-axis current to a first preset value, and setting a γ-axis current to a second preset value; wherein a δ axis and a γ axis are coordinate axes of a target rectangular coordinate system of the two-phase rotating rectangular coordinate system, and a positive direction of the γ axis is a direction of the current vector;
wherein the first preset value is a non-positive value and the second preset value is a non-negative value.

20. The method according to claim 19, further comprising:
under a condition that a torque of the γ-axis current is detected to be larger than a preset threshold, adjusting the γ-axis current to a third preset value; and
under a condition that the torque of the γ-axis current is detected to be smaller than the preset threshold, adjusting the γ-axis current to 0;
wherein the third preset value is greater than 0.
